(19) United States
(12) Patent Application Publication
(10) Pub. No.: US 2023/0196155 A1
(43) Pub. Date: Jun. 22, 2023

(54) OBFUSCATION OF QUANTUM CIRCUITS

(71) Applicant: International Business Machines Corporation, Armonk, NY (US)

(72) Inventors: Dmitri Maslov, New Canaan, CT (US); Pawel Wocjan, Oviedo, FL (US); Jay Michael Gambetta, Yorktown Heights, NY (US)

(21) Appl. No.: 17/645,083

(22) Filed: Dec. 20, 2021

(51) Int. Cl. G06N 10/20; G06F 21/14

(52) U.S. Cl. CPC G06N 10/20; G06F 21/14

(57) ABSTRACT

One or more systems, computer-implemented methods and/or computer program products provided herein relate to obfuscating an input specification of a quantum circuit, one or more gate parameters of a quantum circuit, and/or at least a portion of a quantum circuit. A system can comprise a processor, operatively coupled to a memory, wherein the processor executes the following computer executable components: an obfuscation component that encodes an original quantum control computation by introducing a specified variable into the original quantum control computation, wherein the introduction of the specified variable creates an encoded quantum control computation that is decodable by performing a quantum compiling operation on the encoded quantum control computation.

### FIELD OF INVENTION

Quantum computing is generally the use of quantum-mechanical phenomena to perform computing and information processing functions.

### BACKGROUND

Quantum computing can be viewed in contrast to classical computing, which generally operates on binary values with transistors. That is, while classical computers can operate on bit values that are either 0 or 1, quantum computers operate on quantum bits (qubits) that comprise superpositions of both 0 and 1. Quantum computing has the potential to solve problems that, due to computational complexity, cannot be solved or can only be solved slowly on a classical computer.

On a large scale, quantum computing cloud service providers can execute millions of quantum jobs for users during a year. Each quantum job can include the execution of one or more quantum programs. Where qubit states only can exist (or can only be coherent) for a limited amount of time, an objective of operation of a quantum logic circuit (e.g., including one or more qubits) can be to reduce the time of the operation and/or increase the speed of the operation. Time spent to operate the quantum logic circuit can undesirably reduce the available time of operation on one or more qubits. This can be due to the available coherence time of the one or more qubits prior to decoherence of the one or more qubits. For example, a qubit state can be lost in less than 100 to 200 microseconds in some cases. Further, operations on qubits generally introduce some error, such as some level of decoherence and/or some level of quantum noise, further affecting qubit availability. Quantum noise can refer to noise attributable to the discrete and/or probabilistic natures of quantum interactions. Device designs that prolong the lifetime of the quantum state and extend the coherence time can be desirable.

Also, on the large scale, a large quantity of quantum jobs can create pressure to execute the respective quantum programs quickly. That is, increased speed of execution can directly and/or indirectly correlate to maximizing system usage, minimizing users having to wait for measurement results, and/or minimizing undesirable consuming of classical computational resources. Pressure also can be created to execute these quantum jobs well, so that a most performance can be extracted from near-term error-prone systems and/or so that a quality of measurements relative to the one or more qubits of the respective quantum systems compiling into physical-level pulses can be improved (e.g., related to accuracy, precision and/or measurement efficiency).

Physical, real-world, quantum logic circuits controlled by a quantum system can include a plurality of qubits. One type of qubit, a superconducting qubit, can include a Josephson junction, and operates generally only within a cryogenic chamber, such as a dilution refrigerator. One or more such superconducting qubits can be multiplexed per measurement circuit contained within the cryogenic chamber.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products facilitate a process to obfuscate a quantum circuit specification, one or more quantum circuit parameters and/or an entire quantum circuit. In the quantum computing space, one or more embodiments described herein can facilitate a process to alter a quantum circuit such as to secure (e.g., encode) information of the quantum circuit, where the obfuscated quantum circuit can be compiled down to an original version, such as by employing a decoding key.

In accordance with an embodiment, a system can comprise a processor, operatively coupled to a memory, wherein the processor executes the following computer executable components: an obfuscation component that encodes an original quantum control computation by introducing a specified variable into the original quantum control computation, wherein the introduction of the specified variable creates an encoded quantum control computation that is decodable by a quantum compiling operation on the encoded quantum control computation.

In accordance with another embodiment, a computer-implemented method can comprise encoding, by a system operatively coupled to a processor, an original quantum control computation by introducing a specified variable into the original quantum control computation, wherein the introduction of the specified variable creates an encoded quantum control computation that is decodable by performing, by the system, a quantum compiling operation on the encoded quantum control computation.

In accordance with another embodiment, a computer program product, for facilitating a process to obfuscate a quantum control computation, can comprise a non-transitory computer readable storage medium having program instructions embodied therewith, the program instructions executable by a processor to cause the processor to encode, by the processor, an original quantum control computation by introducing a specified variable into the original quantum control computation, wherein the introduction of the specified variable creates an encoded quantum control computation that is decodable by performing, by the processor, a quantum compiling operation on the encoded quantum control computation.

An advantage of the system, computer-implemented method and/or computer program product can be that an outside third party, eavesdropper, hacker, cloud provider and/or quantum-service provider can be unable to determine at least one of a quantum specification, quantum gate parameter and/or a portion or entirety of the original quantum circuit (e.g., quantum control computation). That is, by obfuscating (e.g., encoding) at least an element of the original quantum control computation, the original quantum control computation can be secured and/or encoded at least partially. Depending on the level of obfuscation, the encoded quantum control computation can still be executed by employing a quantum processor, such as on a respective quantum system. Alternatively, depending on the level of obfuscation, a decoding of the encoded quantum control computation can be employed prior to execution of the decoded quantum control computation.

In one or more embodiments of the system, computer-implemented method and/or computer program product, decoding can further be facilitated by employed a decoding key, where the decoding key can be generated by the obfuscation component. An advantage of this can be employment of a secret and/or otherwise undisclosed key, allowing for limited access.

In one or more embodiments of the system, computer-implemented method and/or computer program product, the specified variable can comprise a gate, a gate string, a qubit rotation value, or a modification to a qubit rotation value of the original quantum control computation. An advantage of this can be generation of an encoded quantum control computation that can be too complex, difficult and/or large to execute by other than a sufficiently large, and/or complex quantum processor and/or quantum system. Size and/or complexity of a quantum processor and/or quantum system can be based on physical, real-world qubit quantity, qubit layout and/or qubit control software of the quantum processor and/or quantum system.

In one or more embodiments of the system, computer-implemented method and/or computer program product, the specified variable can comprise n-qubit Pauli-X layer. An advantage of this can be inability to decode the encoded quantum control computation absent use of a decoding key, where the decoding key can be known only by the generator of the n-qubit Pauli-X layer.

In one or more embodiments of the system, computer-implemented method and/or computer program product, the encoding can comprise increasing a size of the quantum control computation polynomially. An advantage of this can be generation of an encoded quantum control computation that can be too complex, difficult and/or large to execute by other than a sufficiently large, and/or complex quantum processor and/or quantum system, such as where a client intends to execute the original quantum control computation in the first instance. Size and/or complexity of a quantum processor and/or quantum system can be based on physical, real-world qubit quantity, qubit layout and/or qubit control software of the quantum processor and/or quantum system.

In accordance with yet another embodiment, a system can comprise a processor, operatively coupled to a memory, wherein the processor executes the following computer executable components: an obfuscation component that encodes an original quantum control computation by introducing a n-qubit Pauli-X layer into the original qubit control computation, wherein the introduction of the specified variable creates an encoded quantum control computation that is decodable by employing a decoding key.

In accordance with yet another embodiment, a computer-implemented method can comprise encoding an original quantum control computation by introducing a n-qubit Pauli-X layer into the original qubit control computation, wherein the introduction of the specified variable creates an encoded quantum control computation that is decodable by employing a decoding key.

An advantage of the aforementioned system and/or computer-implemented method can be inability to decode the encoded quantum control computation absent use of a decoding key, where the decoding key can be known only by the generator of the n-qubit Pauli-X layer. As such, an advantage of the system, computer-implemented method and/or computer program product can be that an outside third party, eavesdropper, hacker, cloud provider and/or quantum-service provider can be unable to determine at least one of a quantum specification, quantum gate parameter and/or a portion or entirety of the original quantum circuit (e.g., quantum control computation). That is, by obfuscating (e.g., encoding) at least an element of the original quantum control computation, the original quantum control computation can be secured and/or encoded at least partially. The encoded quantum control computation can be non-executable until decoded.

### DESCRIPTION OF THE DRAWINGS

FIG. 1 illustrates a block diagram of an example, non-limiting system that can facilitate obfuscation relative to a quantum circuit, in accordance with one or more embodiments described herein.

FIG. 2 illustrates a block diagram of another example, non-limiting system that can facilitate obfuscation relative to a quantum circuit, in accordance with one or more embodiments described herein.

FIG. 3 illustrates a process diagram of a method of obfuscating an input specification of a quantum circuit, in accordance with one or more embodiments described herein.

FIG. 4 illustrates a process diagram of a method of obfuscating at least a portion of a quantum circuit, in accordance with one or more embodiments described herein.

FIG. 5 illustrates a process diagram of a method of obfuscating one or more gate parameters of a quantum circuit, in accordance with one or more embodiments described herein.

FIG. 6 illustrates a pair of schematic diagrams showing difference between an original quantum circuit and an obfuscated quantum circuit, in accordance with one or more embodiments described herein.

FIG. 7 illustrates a process diagram of a method of obfuscating an input specification of a quantum circuit, one or more gate parameters of a quantum circuit, and/or at least a portion of a quantum circuit, in accordance with one or more embodiments described herein.

FIG. 8 illustrates a block diagram of an example, non-limiting, operating environment in which one or more embodiments described herein can be facilitated.

FIG. 9 illustrates a block diagram of an example, non-limiting, cloud computing environment in accordance with one or more embodiments described herein.

FIG. 10 illustrates a block diagram of example, non-limiting, abstraction model layers in accordance with one or more embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. However, in various cases, that the one or more embodiments can be practiced without these specific details.

Quantum computation utilizes a qubit as its essential unit instead of a classical computing bit. A qubit (e.g., quantum binary digit) is a quantum-mechanical analog of a classical bit. Whereas classical bits can employ only one of two basis states (e.g., 0 or 1), qubits can employ superpositions of those basis states (e.g., α|0〉 + β|1〉, where α and β are complex scalars (such that |α|²+|β|² = 1), allowing several qubits to theoretically hold exponentially more information than the same number of classical bits. Thus, quantum computers (e.g., computers that employ qubits instead of solely classical bits) can, in theory, quickly solve problems that can be extremely difficult for classical computers. The bits of a classical computer are simply binary digits, with a value of either 0 or 1. Almost any device with two distinct states can serve to represent a classical bit: a switch, a valve, a magnet, a coin, or similar binary-type state measure. Qubits, partaking of the quantum mystique, can occupy a superposition of 0 and 1 states. It is not that the qubit can have an intermediate value, such as 0.63; when the state of the qubit is measured, the result is either 0 or 1. But in the course of a computation, a qubit can act as if it were a mixture of states-for example: 63 percent 0 and 37 percent 1.

Indeed, general quantum programs can employ coordination of quantum and classical parts of a computation. One way to contemplate general quantum programs is to identify processes and abstractions involved in specifying a quantum algorithm, transforming the algorithm into executable form, running an experiment or simulation, and analyzing the results. A notion throughout these processes is use of intermediate representations. An intermediate representation (IR) of computation is neither its source language description nor target machine instructions, but something in between. Compilers can utilize several IRs during a process of translating and optimizing a program. An input is a source code describing a quantum algorithm and compile time parameter(s). An output is a combined quantum/classical program expressed using a high-level IR. A distinction between quantum and classical computers is that the quantum computer is probabilistic, thus measurements of algorithmic outputs provide a proper solution within an algorithm specific confidence interval. Computation is repeated until a satisfactory probable certainty of solution can be achieved.

Quantum computers can offer novel ways to perform computation tasks such as molecular calculations, optical photons, optimization, and many more. Many algorithms and system components can be introduced to perform such computational tasks efficiently.

Quantum circuits are transformations that operate on a set of qubits. Quantum circuits can be represented by one or more unitary matrices (e.g., unitary operators), i.e., surjective bounded operators on a Hilbert space that preserve the respective inner product and/or norm of the Hilbert space. Each unitary matrix can be a matrix (e.g., a quantum or unitary matrix) that can represent the quantum function and/or computations that can be performed by the unitary matrix. For example, a quantum circuit operating on n qubits for any suitable positive integer n can be represented by a 2ⁿ x 2ⁿ unitary matrix. The quantum state of a set of qubits can be represented by a quantum state vector (e.g., for n qubits, a quantum state vector can have 2ⁿ elements), and quantum circuits can be applied to a quantum state vector via matrix multiplication. Quantum circuits can be combined in series via matrix multiplication and/or can be combined in parallel via tensor products (e.g., Kronecker products). Quantum circuits, for instance as part of a quantum program, can operate one or more physical operations on a set of qubits, such as being implemented as a sequence of pulses.

On a large scale, quantum computing cloud service providers can execute millions of quantum jobs for users during a year. Each quantum job can include the execution of one or more quantum programs. The aforementioned quantity of quantum jobs can create pressure to execute the respective quantum programs quickly and securely. Indeed, it can be desirable to secure from outside parties, eavesdroppers, a cloud provider and/or a service provider of a quantum system one or more elements and/or intentions of a quantum circuit being employed. In one or more examples, these elements can include an input or specification, one or more gate parameters, and/or even a portion of or an entire quantum circuit.

In another case, an entity’s intentions for running a quantum computation can be secretive. For example, a user can intend to execute a Shor’s algorithm. An unobfuscated specification related thereto can reveal a number being factored. In Rivest-Shamir-Adleman (RDA) cryptosystems, this number can be a public key. Looking up this public key can reveal one party of those communicating and thus be dispositive as to which party’s security is being compromised by the intended factoring. As a result, such understanding can, in one or more cases, reveal one or more intentions of the entity running the quantum computation.

Regardless of the particular one or more reasons, it can be desirable to secure (e.g., encode) such one or more elements of a quantum circuit, which securing can be provided at least partially, and/or fully, at a client computer, device, apparatus and/or system, such as to limit access even to a cloud provider or quantum service provider. Further, by securing the one or more elements of a quantum circuit a party’s intentions in running and/or seeking to run the quantum circuit can be secured.

To that end, the one or more embodiments described herein relate to techniques for providing quantum circuit obfuscation at different levels, such as relative to an input state specification, one or more gate parameters, and/or even a portion of or an entire quantum circuit. These different processes can be employed separately and/or in combination.

One or more embodiments are now described with reference to the drawings, where like referenced numerals are used to refer to like elements throughout. As used herein, the terms “entity”, “requesting entity” and “user entity” can refer to a machine, device, component, hardware, software, smart device and/or human. In the following description, for purposes of explanation, numerous specific details are set forth in order to provide a more thorough understanding of the one or more embodiments. However, in various cases, that the one or more embodiments can be practiced without these specific details.

Generally, the subject computer processing system(s), methods, apparatuses, devices and/or computer program products can be employed to solve new problems that can arise through advancements in technology, computer networks, the Internet and the like.

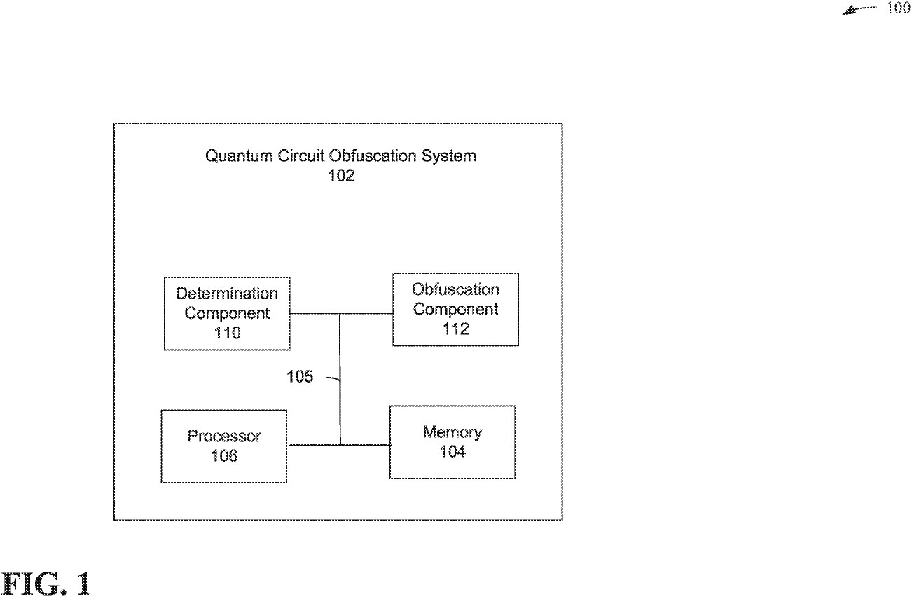

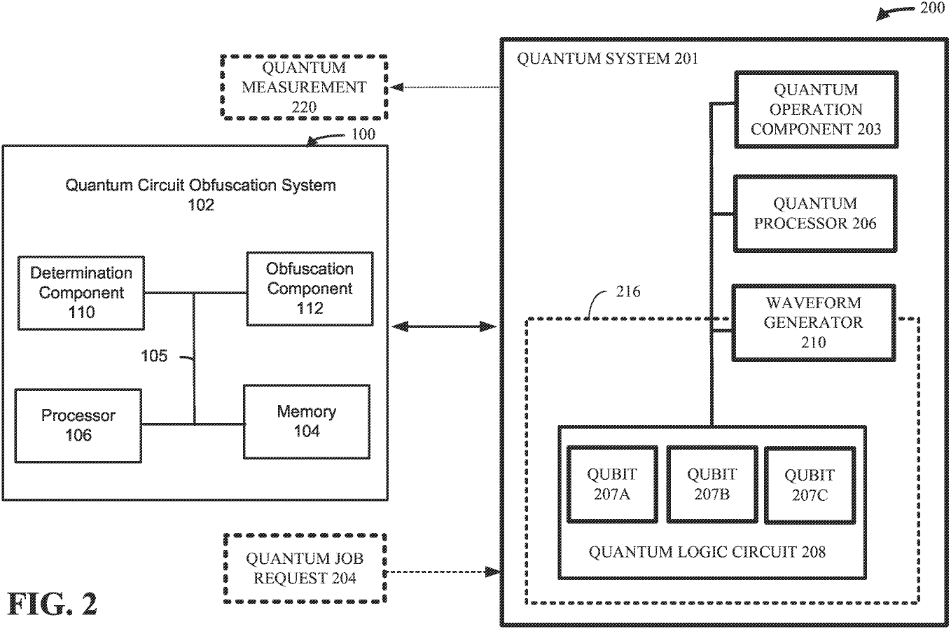

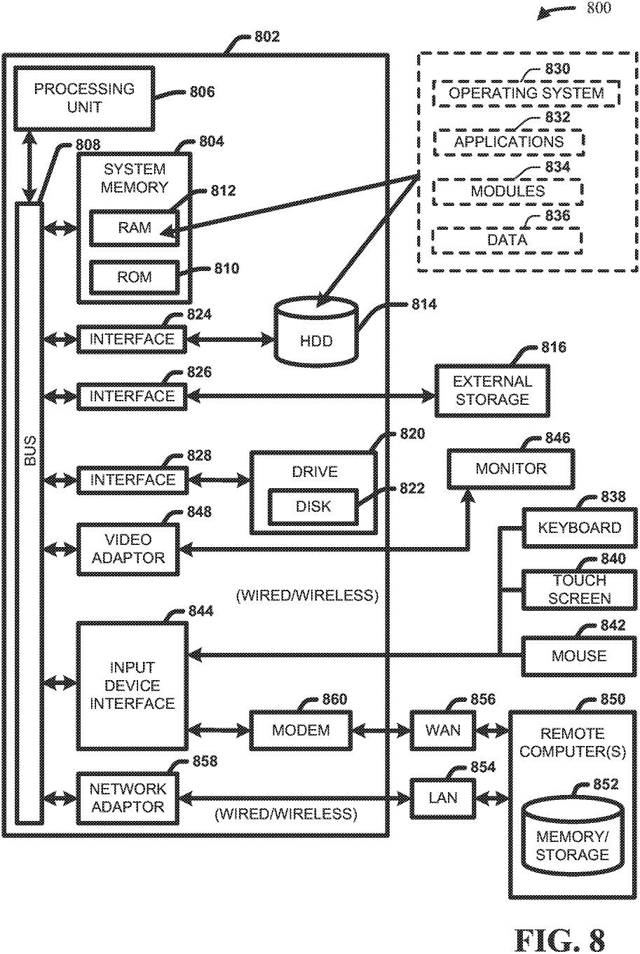

Further, the embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, the non-limiting system 200 as illustrated at FIG. 2, and/or systems thereof, can further comprise, be associated with and/or be coupled to one or more computer and/or computing-based elements described herein with reference to an operating environment, such as the operating environment 800 illustrated at FIG. 8. In one or more described embodiments, computer and/or computing-based elements can be used in connection with implementing one or more of the systems, devices, components and/or computer-implemented operations shown and/or described in connection with FIG. 1, FIG. 2 and/or with other figures described herein.

Turning first generally to FIG. 1, one or more embodiments described herein can include one or more devices, systems and/or apparatuses that can facilitate obfuscation of a quantum circuit. For example, FIG. 1 illustrates a block diagram of an example, non-limiting system 100 that can encode a quantum circuit while still enabling the execution of the quantum circuit relative to a quantum logic circuit including one or more qubits.

In one or more embodiments, the quantum circuit obfuscation system 102 can comprise a processor 106 (e.g., computer processing unit, microprocessor, classical processor, quantum processor and/or like processor). In one or more embodiments, any component associated with quantum circuit obfuscation system 102, as described herein with or without reference to the one or more figures of the one or more embodiments, can comprise one or more computer and/or machine readable, writable and/or executable components and/or instructions that can be executed by processor 106 to facilitate performance of one or more processes defined by such component(s) and/or instruction(s). In one or more embodiments, the processor 106 can comprise the determination component 110 and/or the obfuscation component 112.

Processor 106 can comprise one or more types of processors and/or electronic circuitry (e.g., a classical processor, a quantum processor, etc.) that can implement one or more computer and/or machine readable, writable, and/or executable components and/or instructions that can be stored on memory. For example, the processor 106 can perform various operations that can be specified by such computer and/or machine readable, writable, and/or executable components and/or instructions including, but not limited to, logic, control, input/output (I/O), arithmetic, and/or the like. The processor 106 can comprise one or more central processing unit (CPU), multi-core processor, microprocessor, dual microprocessors, microcontroller, System on a Chip (SOC), array processor, vector processor, quantum processor, and/or another type of processor. Such examples of the processor can be employed to implement any embodiments described herein.

In one or more embodiments, the quantum circuit obfuscation system 102 can comprise a computer-readable memory 104 that is operably connected to the processor 106. The memory 104 can store computer-executable instructions that, upon execution by the processor 106, can cause the processor 106 and/or other components of the quantum circuit obfuscation system 102 (e.g., the determination component 110 and/or the obfuscation component 112) to perform one or more acts. In one or more embodiments, the memory 104 can store computer-executable components (e.g., the determination component 110 and/or the obfuscation component 112).

The memory 104 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Such examples of the memory 104 can be employed to implement any one or more embodiments described herein.

The quantum circuit obfuscation system 102 and/or a component thereof as described herein can be communicatively, electrically, operatively, optically and/or otherwise coupled to one another via a bus 105 to perform functions of non-limiting system 100, quantum circuit obfuscation system 102 and/or any components thereof and/or coupled therewith. Bus 105 can comprise one or more of a memory bus, memory controller, peripheral bus, external bus, local bus, quantum bus and/or another type of bus that can employ one or more bus architectures. One or more of these examples of bus 105 can be employed to implement any one or more embodiments described herein.

In addition to the processor 106 and/or memory 104 described above, quantum circuit obfuscation system 102 can comprise one or more computer and/or machine readable, writable and/or executable components and/or instructions that, when executed by processor 106, can facilitate performance of one or more operations defined by such component(s) and/or instruction(s).

In one or more embodiments, quantum circuit obfuscation system 102 can be coupled (e.g., communicatively, electrically, operatively, optically and/or like function) to one or more external systems, sources and/or devices (e.g., classical and/or quantum computing devices, communication devices and/or like devices), such as via a network. In one or more embodiments, one or more of the components of the non-limiting system 100 can reside in the cloud, and/or can reside locally in a local computing environment (e.g., at a desired location(s)).

In one or more embodiments, the quantum circuit obfuscation system 102 can be coupled (e.g., communicatively, electrically, operatively, optically, etc.) to one or more external systems, sources, and/or devices (e.g., classical and/or quantum computing devices, communication devices, etc.) via a network. The network can comprise one or more wired and/or wireless networks, including, but not limited to, a cellular network, a wide area network (WAN) (e.g., the Internet), and/or a local area network (LAN). For example, the quantum circuit obfuscation system 102 can communicate, such as via the controller/processor 306, with one or more external systems, sources, and/or devices, for instance, computing devices using the network, which can comprise virtually any desired wired or wireless technology, including but not limited to: powerline ethernet, wireless fidelity (Wi-Fi), BLUETOOTH®, fiber optic communications, global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies and/or legacy telecommunication technologies, Session Initiation Protocol (SIP), ZIGBEE®, RF4CE protocol, WirelessHART protocol, 6LoWPAN (IPv6 over Low power Wireless Area Networks), Z-Wave, an ANT, an ultra-wideband (UWB) standard protocol, and/or other proprietary and non-proprietary communication protocols. In such an example and as described above, quantum circuit obfuscation system 102 can thus include hardware (e.g., a central processing unit (CPU), a transceiver, a decoder, an antenna, quantum hardware, a quantum processor, etc.), software (e.g., a set of threads, a set of processes, software in execution, quantum pulse schedule, quantum circuit, quantum gates, etc.) or a combination of hardware and software that facilitates communicating information between the quantum circuit obfuscation system 102 and external systems, sources, and/or devices (e.g., computing devices, communication devices, etc.).

Turning now to the other components of the quantum circuit obfuscation system 102, further operation of the quantum circuit obfuscation system 102 will be described.

Generally, the determination component 110 can employ any suitable method to determine, identify and/or otherwise obtain an original quantum circuit (e.g., original quantum control computation). As used herein, the terms quantum control computation and quantum circuit can be interchangeable. The determination can include transfer, receipt, search for and/or the like of the original quantum circuit. In one or more embodiments, the original quantum circuit can be obtained from a database communicatively coupled to the non-limiting system 100, such as to the quantum circuit obfuscation system 102. The determination component 110 can comprise any suitable software and/or hardware.

The obfuscation component 112 generally can obfuscate one or more elements of the original quantum circuit, such as to secure and/or encode the original quantum circuit. For example, the obfuscation component 112 can encode the original quantum circuit by introducing a specified variable into the original quantum circuit. The introduction of the specified variable can thus create, by the obfuscation component 112, an encoded quantum circuit. Depending on the specified variable employed, and/or on one or more specified variables employed, the encoded quantum circuit can be executable or non-executable on a quantum system, relative to one or more real-world, physical qubits. The obfuscation component 112 can comprise any suitable software and/or hardware.

For example, in one or more embodiments, introduction of the specified variable can create an encoded quantum circuit that is decodable by employing a decoding key. The decoding key can be generated by the obfuscation component, such as based upon the specified variable. Thus, decoding of the encoded quantum circuit, using the decoding key, first can be performed prior to execution of the resultant decoded quantum circuit. In one or more embodiments, the encoded quantum circuit can be executed on a quantum system without decoding of a signal measured by respective readout electronics of the quantum system.

Circuit obfuscation comprises increasing a size of the quantum circuit (we keep the increase to at most polynomial). An advantage of this, other than to obfuscate the structure of the circuit and thus hide the nature of the computation being performed, can be the generation of an encoded quantum control computation that can be too complex, too difficult and/or too large to execute absent a sufficiently large, and/or complex quantum processor and/or quantum system, such as a quantum processor and/or quantum system on which a client intends to execute the original quantum control computation in the first instance. Size and/or complexity of a quantum processor and/or quantum system can be based on physical, real-world qubit quantity, qubit layout and/or qubit control software of the quantum processor and/or quantum system.

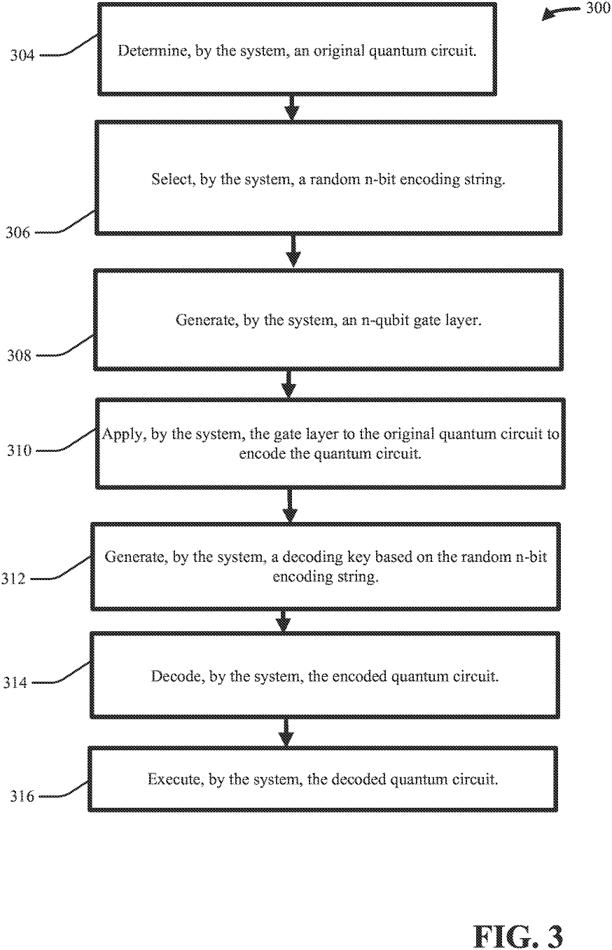

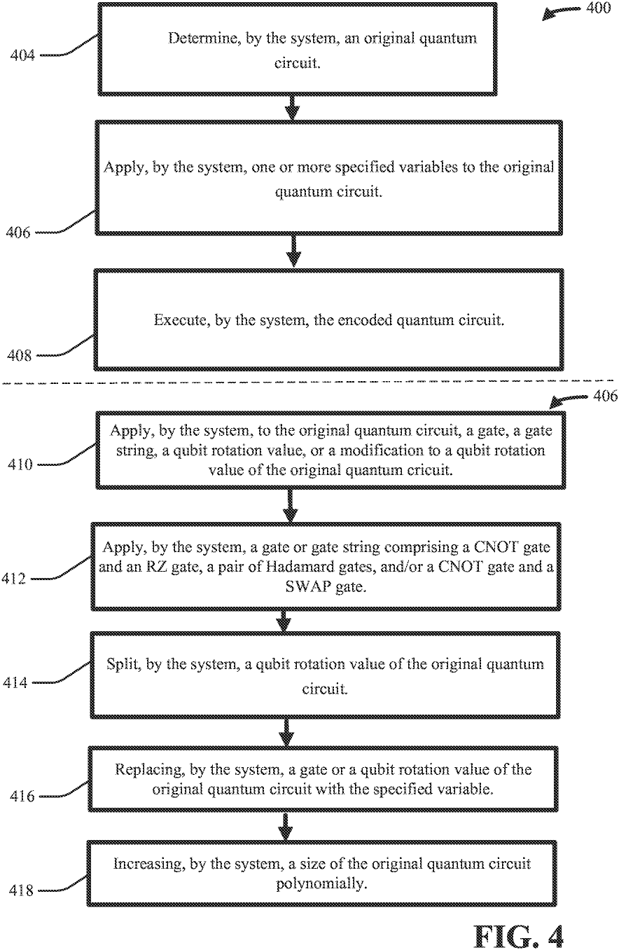

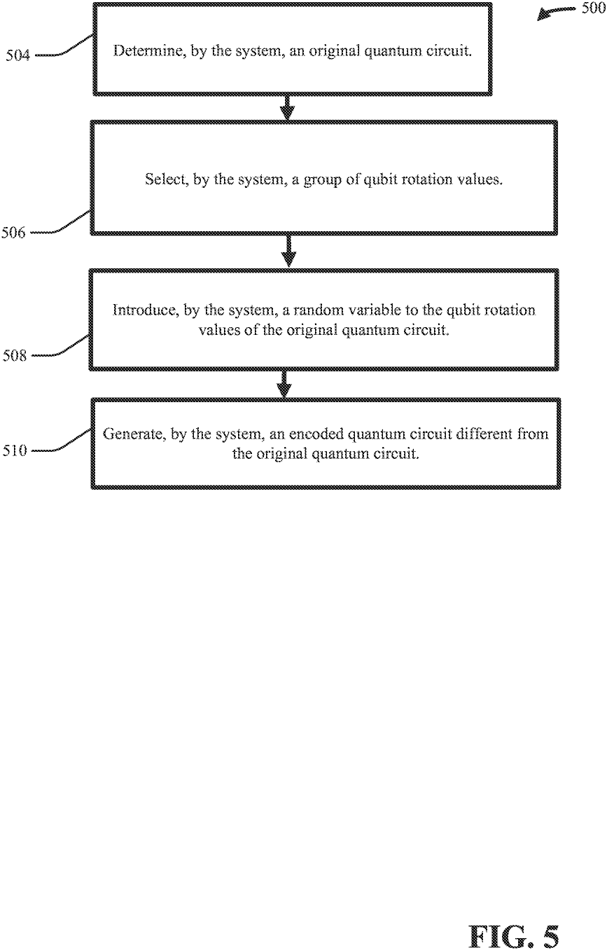

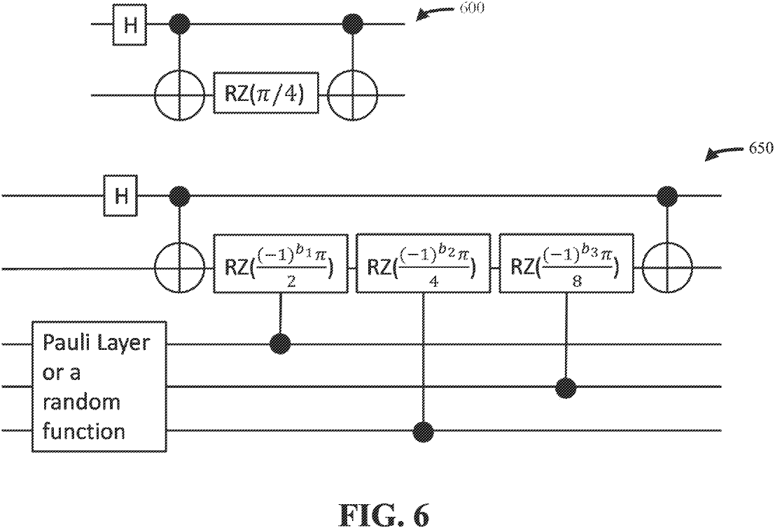

That is, the encoding of the quantum circuit by the obfuscation component 112 can be employed via one or more of a plurality of different methods. In one or more methods, relative to FIG. 3, an input specification or a portion thereof of a quantum circuit can be obfuscated. For example, for an n-qubit circuit, each qubit can be specified to take the value 0 or the value 1, for a total of 2ⁿ possible different input specifications. To execute a computation both the circuit and the input are specified. In one or more methods, relative to FIG. 4, a portion or an entirety of a quantum circuit can be obfuscated, which can include obfuscation of one or more gate parameters. In one or more methods, relative to FIGS. 5 and 6, one or more gate parameters of a quantum circuit can be obfuscated.

Turning first, however, to FIG. 2, one or more embodiments described herein can include one or more devices, systems and/or apparatus that can facilitate obfuscation of a quantum circuit and execution of the quantum circuit as one or more quantum operations to facilitate output of one or more quantum results. For example, FIG. 2 illustrates a block diagram of an example, non-limiting system 200 that can secure a quantum circuit while still enabling execution of the quantum circuit relative to a quantum logic circuit including one or more qubits.

The illustrated non-limiting system 200 can include both a quantum portion (e.g., the quantum system 201) and a classical portion (e.g., the quantum circuit obfuscation system 102). The non-limiting system 200 thus can be a hybrid system. In one or more other embodiments, the quantum system 101 can be separate from, but function in combination with, the non-limiting system 100 and/or the quantum circuit obfuscation system 102.

Relative to the non-limiting system 100 and/or the quantum circuit obfuscation system 102, repetitive description of like elements employed in other embodiments described herein is omitted for sake of brevity.

The quantum system 201 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuity can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement 220, can be responsive to the quantum job request 204 and associated input data and can be based at least in part on the input data, quantum functions and/or quantum computations.

In one or more embodiments, the quantum system 201 can comprise one or more quantum components, such as a quantum operation component 203, a quantum processor 206, a waveform generator 210, and/or a quantum logic circuit 208 comprising one or more qubits (e.g., qubits 207A, 207B and/or 207C), also referred to herein as qubit devices 207A, 207B and 207C.

The quantum processor 206 can be any suitable processor. The quantum processor 206 can generate one or more instructions for controlling the one or more processes of the quantum operation component 203 and/or for controlling the quantum logic circuit 208 using waveform generator 210. In one or more embodiments, the quantum processor 206 can comprise the quantum logic circuit 208.

The quantum operation component 203 can obtain (e.g., download, receive, search for and/or the like) a quantum job request 204 requesting execution of one or more quantum programs. The quantum operation component 203 can determine one or more quantum logic circuits, such as the quantum logic circuit 208, for executing the quantum program.

The quantum job request 204 can include an encoded or decoded quantum circuit provided by the non-limiting system 100 and/or quantum circuit obfuscation system 102. The request 204 can be provided in any suitable format, such as a text format, binary format and/or another suitable format. In one or more embodiments, the request 204 can be received by a component other than a component of the quantum system 201, such as a by a component of a classical system coupled to and/or in communication with the quantum system 201, such as the quantum circuit obfuscation system 102.

The waveform generator 210 can perform one or more quantum processes, calculations and/or measurements for operating one or more quantum circuits on the one or more qubits 207A, 207B and/or 207C. For example, the waveform generator 210 can operate one or more qubit effectors, such as qubit oscillators, harmonic oscillators, pulse generators and/or the like to cause one or more pulses to stimulate and/or manipulate the state(s) of the one or more qubits 207A, 207B and/or 207C comprised by the quantum system 201. That is, the waveform generator 210, such as in combination with the quantum processor 206, can execute operation of a quantum logic circuit on one or more qubits of the circuit (e.g., qubit 207A, 207B and/or 207C). In response, the quantum operation component 203 can output one or more quantum job results, such as one or more quantum measurements 220, in response to the quantum job request 204.

The quantum logic circuit 208 and a portion or all of the waveform generator 210 can be contained in a cryogenic environment, such as generated by a cryogenic chamber 216, such as a dilution refrigerator. Indeed, a signal can be generated by the waveform generator 210 within the cryogenic chamber 216 to effect the one or more qubits 207A-C. Where qubits 207A, 207B and 207C are superconducting qubits, cryogenic temperatures, such as about 4 K or lower can be employed to facilitate function of these physical qubits. Accordingly, the elements of the quantum measurement circuit 110 also are to be constructed to perform at such cryogenic temperatures.

One or more communications between one or more components of the non-limiting system 200 and the classical system 100 can be facilitated by wired and/or wireless means including, but not limited to, employing a cellular network, a wide area network (WAN) (e.g., the Internet), and/or a local area network (LAN). Suitable wired or wireless technologies for facilitating the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an ANT, an ultra-wideband (UWB) standard protocol and/or other proprietary and/or non-proprietary communication protocols.

The following/aforementioned description(s) refer(s) to the operation of a single quantum program from a single quantum job request. However, one or more of the processes described herein can be scalable, also such as including additionally, and/or alternatively, execution of one or more quantum programs and/or quantum job requests in parallel with one another, obfuscation of one or more portions of multiple quantum circuits in parallel with one another, and/or obfuscation of one or more quantum circuit elements and/or portions of a single quantum circuit in parallel with one another.

Turning now to FIG. 3, description is provided regarding one or more methods to facilitate obfuscation of an input specification or a portion thereof of a quantum circuit. An advantage of this can be inability to decode the encoded quantum control computation absent use of a decoding key, where the decoding key can be known only by the generator of the specified variable. As such, an advantage can be that an outside third party, eavesdropper, hacker, cloud provider and/or quantum-service provider can be unable to determine at least one of a quantum specification, quantum gate parameter and/or a portion or entirety of the original quantum circuit (e.g., quantum control computation). That is, by obfuscating (e.g., encoding) at least an element of the original quantum control computation, the original quantum control computation can be secured and/or encoded at least partially. The encoded quantum control computation can be non-executable until decoded.

In a case where a client has only classical computer capabilities, the obfuscation of an input specification of a quantum circuit, by the obfuscation component 112, can be employed. Likewise, where a quantum circuit does not pose a secret, it also can be desired to obfuscate the input specification of the quantum circuit. In addition, such input obfuscation can be employed in addition to quantum circuit obfuscation by other means, including gate parameter obfuscation and/or entire/partial circuit obfuscation.

Generally, a random n-bit encoding string can be selected and/or generated, such as by a random number generator comprised by or communicatively coupled to the obfuscation component 112. Using the n-bit encoding string, an n-qubit Pauli gate layer can be generated by the obfuscation component 112. As used herein, a Pauli layer is defined to be an arbitrary n-qubit transformation applying the identity I, Pauli-X, Pauli-Y, or Pauli-Z gate to each of the qubits. In one or more embodiments, a Pauli-X layer can only apply I or X.

This n-qubit Pauli gate layer can be classically propagated through quantum gates of the quantum circuit to both encode the quantum circuit and to generate a decoding key. Decoding of the measurement result obtained from executing the encoded quantum circuit can be accomplished only by employing the decoding key. Because only the user or generator or obfuscation component 112 comprises the encoding and decoding keys, only the user can decode the intended output given the measurement result over encoded circuit.

In one example, assume a quantum computation (e.g., quantum circuit) can be given as a Clifford gate and RZ gate circuit. Alternatively, a quantum circuit can be compiled, such as by the obfuscation component 112 to a Clifford gate and RZ gate circuit. An encoding input can be given by the n-bit input string |in〉. The quantum circuit to be obfuscated and/or executed can be identified as C.

A random n-bit encoding string |s〉 can be selected by the obfuscation component 112, random number generator, and/or user. This random n-bit s encoding string can be the specified variable introduced to the quantum circuit C to thereby encode the quantum circuit C. As indicated, an n-qubit layer, such as a Pauli-X layer, can be generated, where gates X can be applied to all qubits i, relative to the original quantum circuit C, where sᵢ ⊕ inᵢ = 1. That is, the Pauli gates can be introduced to, such as pushed through, the quantum circuit C to the end of the quantum circuit C, therefore obtaining an encoded quantum circuit having a specification C′. To execute the encoded quantum circuit, the encoded input |in ⊕ s) and encoded quantum circuit C′ can be provided, such as to a cloud provider and/or such as to the quantum system 201.

The encoded quantum circuit C′can be employed to perform the desired computation. The output of the encoding, as provided by the server is |out〉. It cannot be used directly because it is encoded. The desired output, e, g., a decoded output, can be obtained as |out ⊕ k〉, where the Boolean string k is obtained by taking the Pauli-X layer described by the specified variable n-bit encoding string s, pushing this layer through the original/unencoded circuit C, and replacing Pauli gates with binary values at each qubit i as follows: I, Z → 0 and X, Y → 1 in the final Pauli layer.

Pauli gate pushing for encoding the circuit can comprise the following operations, grouped to show how the pushing applies to Pauli-X, Pauli-Y, and Pauli-Z gates:
I. Pushing X.
   1. X a; H a H a; Z a
   2. X a; Pa → Pa; Ya
   3. X a; CNOT b a → CNOT b a; X a (target qubit last)
   4. X a; CNOT a b → CNOT a b; X a; X b
   5. X a; RZ[angle] a → RZ[-angle] a; X a
II. Pushing Z:
   1. Z a; H a H a; X a
   2. Z a; P a → P a; Z a
   3. Z a; CNOT b a → CNOT b a; Z a; Z b
   4. Z a; CNOT a b → CNOT a b; Z a
   5. Z a; RZ[angle] a → RZ[angle] a; Z a
III. Pushing Y: since Y~ZX, rules I and II can be adapted to handle Y.

For decoding, the measured output is EXORed (e.g., employing an exclusive OR gate or XOR gate) with the computed decoding key. The decoding key is the result of pushing the encoding Pauli layer to the end of the circuit.

Relative to this method of obfuscation, e.g., of an input specification of a quantum circuit, FIG. 3 illustrates a process diagram of an example, non-limiting method 300 that can facilitate obfuscation of at least a portion of a quantum circuit input specification. Repetitive description of like elements and/or processes employed in respective embodiments is omitted for sake of brevity.

At 304, the non-limiting method 300 can comprise determining, by a system, (e.g., determination component 110) an original quantum control computation.

At 306, the non-limiting method 300 can comprise selecting, by the system (e.g., obfuscation component 112), a random n-bit encoding string (e.g., random n-bit encoding string |s〉, as indicated above), such as by a random number generator comprised by or communicatively coupled to the obfuscation component 112, as indicated above.

At 308, the non-limiting method 300 can comprise generating, by the system (e.g., obfuscation component 112), an n-qubit gate layer (e.g., the an n-qubit Pauli gate layer employed above), based on the random n-bit encoding string, where the n-qubit gate layer is to be introduced to the original quantum control computation as the specified variable.

At 310, the non-limiting method 300 can comprise applying (e.g., introducing), by the system (e.g., obfuscation component 112), the gate layer to the original quantum control computation to encode the quantum control computation (e.g., resulting in the encoded quantum circuit C′). In the example above, it is noted that the Pauli gates can be introduced to, such as pushed through, the quantum circuit C to the end of the quantum circuit C, therefore obtaining an encoded quantum circuit having a specification C′. Pauli X, Y and Z gate pushing can be employed.

At 312, the non-limiting method 300 can comprise generating, by the system (e.g., obfuscation component 112), the decoding key based on the random n-bit encoding string and/or on the given unencoded circuit. In one or more embodiments, the process of generating the decoding key can produce the encoded circuit. For example, the decoding key can be the result of pushing the encoding Pauli layer to the end of the circuit.

At 314, the non-limiting method 300 can comprise decoding, by the system (e.g., obfuscation component 112), the encoded quantum control computation (e.g., encoded quantum circuit C′). This can comprise where the measured output is EXORed (e.g., employing an exclusive OR gate or XOR gate) with the computed decoding key.

At 316, the non-limiting method 300 can comprise executing, by the system (e.g., quantum system 201), the decoded quantum circuit.

Turning next to FIG. 4, description is provided regarding one or more methods to facilitate obfuscation of at least a portion or more, such as an entirety, of a quantum circuit. These one or more methods can be based on an inability of a hacker, third party, eavesdropper and/or cloud provider, for example, to be capable of employing sufficient transformations to deobfuscate the encoded (e.g., obfuscated) quantum circuit. Reversing the obfuscation implies the ability to solve a set of complex compiling problems (at least NP-Complete/QMA-Complete), and it is unlikely to be possible.

For example, an advantage of this can be generation of an encoded quantum control computation that can be too complex, difficult and/or large to execute by other than by a sufficiently large, and/or complex quantum processor (e.g., comprising a quantum logic circuit) and/or quantum system, such as where a client intends to execute the original quantum control computation in the first instance. Size and/or complexity of a quantum processor and/or quantum system can be based on physical, real-world qubit quantity, qubit layout and/or qubit control software of the quantum processor and/or quantum system.

In one or more embodiments, obfuscation can perform anti-optimization compilations, such as can make a quantum circuit more secure, but can also make a quantum circuit more complex. That is, one or more difficulties with compiling a quantum circuit can be employed in reverse, such as to create such difficulties and/or to add complexity to already existing one or more of such difficulties. Such difficulties can include, although without being limiting, space-time trade-offs such as replacing qubits with gates, minimizing a number of gates and/or finding qubit assignments, such that a quantum circuit cost (e.g., processing power, time, memory, qubit number, and/or the like) of an implementation of a quantum circuit is minimized. That is, the one or more methods described herein can provide the opposite, such as adding complexity to a space-time trade-off such as replacing gates with qubits, and a number of gates, and/or adding SWAP gates (and/or other gates) such that quantum circuit cost is increased.

Indeed, again, one or more specified variables can be introduced to an original quantum circuit, such as by the obfuscation component 112. The one or more specified variables can comprise one or more of a gate, a gate string, a qubit rotation value, and/or a modification to a qubit rotation value of the original quantum circuit. The gate or gate string can comprise a CNOT gate and an RZ gate, a pair of Hadamard gates and/or a CNOT gate and a SWAP gate, for example. The modification to a qubit rotation value of the original quantum circuit can comprise splitting a qubit rotation value. The encoding can further comprise replacing a gate or a qubit rotation value of the original quantum circuit with a specified variable, such as replacing a gat by commuting together two or more gates. Any one or more of these techniques can increase a size of the quantum circuit, such as even polynomially.

Attention now turns to more detailed description of the aforementioned methods and/or techniques to add complexity to, and thus obfuscate, a quantum circuit and/or a portion thereof.

In one or more embodiments, assume a quantum computation (e.g., quantum circuit) can be given as a Clifford gate and RZ gate circuit. Alternatively, a quantum circuit can be compiled, such as by the obfuscation component 112 to a Clifford gate and RZ gate circuit. Although, in one or more embodiments, compiling to a Clifford gate and RZ gate circuit can be omitted. In response thereto, one or more additional and/or new qubits, such as more than employed by the original (e.g., non-obfuscated) quantum circuit, can be introduced into the original quantum circuit to “encode” the quantum circuit.

A random circuit can be implemented on such introduced qubits, such as by the obfuscation component 112. As such, after execution of the encoded quantum circuit, computation resulting from this random circuit can be discarded, such as by the obfuscation component 112, quantum processor 206 and/or quantum operation component 203. Indeed, such computation is generally non-related to the end result, and results due to the obfuscation.

In one or more embodiments, assume a quantum computation (e.g., quantum circuit) can be given as a Clifford gate and RZ gate circuit. Alternatively, a quantum circuit can be compiled, such as by the obfuscation component 112 to a Clifford gate and RZ gate circuit. In response thereto, a number of gates of the original quantum circuit can be increased. This increase can include one or more varying sub-techniques. Any of such sub-techniques can be performed by the obfuscation component 112.

One or more qubit rotation values, such as RZ rotation values, can be split. For example, RZ(a) can be split to RZ(x)RZ(a-x), and RZ(x) can be moved away from (e.g., commuted from) RZ(ax).

One or more database accessible templates can be employed, such as to replace fewer gates with more. This can include entangling C (payload circuit) and R (redundant circuit portion).

A CNOT gate and RZ gate circuit portion can be introduced, such as inserted into the quantum circuit. For example, random linear function of qubits (some from C some from R) can be identified and/or selected by the obfuscation component 112 and/or user. This random linear function can be implemented by a random CNOT circuit C₁ according to the following: for each subset of variables either choose to keep the sum on the top or the bottom qubit; similarly, create a random circuit C₂; compose and optimize

$${C}_{3} : = {C}_{1}^{- 1} {C}_{2}$$

such that

$${C}_{1} {\text{RZ}}^{v} \left(α\right) {C}_{3} {\text{RZ}}^{v} \left(- α\right) {C}_{2}^{- 1}$$

computes the identity, where v is the qubit that accumulates the given linear function; insert C₃ and commute as many CNOTs as far as possible, including semi-commuting them (to illustrate, a CNOT can semi-commute to the right of H as follows: CNOT(a,b)H(b)→H(b)CZ(a,b)---i.e., CNOT can commute but change its nature).

A pair of Hadamard gates can be introduced into the quantum circuit. The pair of Hadamard gates can be local Hadamard gates.

Turning away now from the sub-techniques to additional methods for obfuscation of a portion or entirety of a quantum circuit, in one or more embodiments, a CNOT gate and SWAP gate can be introduced. For example, one or more adjacent pairs of CNOT(a,b)CNOT(b,a) can be identified, such as by the obfuscation component 112. One or more of the identified pairs can be replaced, such as by the obfuscation component 112, with a CNOT(b,a)SWAP(a,b) gate pair. The SWAP gate can be factored out by pushing the SWAP gate to the end of the circuit while relabeling qubit names.

Any of the above-described techniques and/or sub-techniques can be employed in any suitable order, and/or any one or more of the above-described techniques and/or sub-techniques can be employed.

Indeed, any one of the aforementioned techniques and/or sub-techniques can be employed multiple times, such as employing multiple iterations by the obfuscation component 112, with or without one or more other of the aforementioned techniques and/or sub-techniques employed therebetween a pair of iterations thereof. For example, a random number of times any one or more of the aforementioned techniques and/or sub-techniques is to be applied can be selectively determined by the obfuscation component 112 and/or user.

As a result of employing any one or more of the aforementioned techniques and/or sub-techniques, the encoded quantum circuit can be an obfuscated quantum circuit such that a third party cannot determine where R is in the encoded quantum circuit, cannot decrease the number of gates without access to a quantum system, and/or cannot determine an order of outputs of the encoded quantum circuit after the inputs of R are revealed (e.g., conveyed). As indicated above R can be a redundant circuit portion that can serve to obfuscate the true computation given by C.

Relative to these one or more methods of obfuscation, e.g., of an input specification of a quantum circuit, FIG. 4 illustrates a process diagram of an example, non-limiting method 400 that can facilitate obfuscation of at least a portion of a quantum circuit input specification. Repetitive description of like elements and/or processes employed in respective embodiments is omitted for sake of brevity.

At 404, the non-limiting method 400 can comprise determining, by a system, (e.g., determination component 110) an original quantum control computation.

At 406, the non-limiting method 400 can comprise applying, by the system (e.g., obfuscation component 112), one or more specified variables to the original quantum control computation. As indicated above, the one or more specified variables can comprise one or more of a gate, a gate string, a qubit rotation value, and/or a modification to a qubit rotation value of the original quantum circuit. The gate or gate string can comprise a CNOT gate and an RZ gate, a pair of Hadamard gates and/or a CNOT gate and a SWAP gate, for example. The modification to a qubit rotation value of the original quantum circuit can comprise splitting a qubit rotation value. The encoding can further comprise replacing a gate or a qubit rotation value of the original quantum circuit with a specified variable, such as replacing a gate by commuting together two or more gates.

At 408, the non-limiting method 400 can comprise executing, by the system (e.g., quantum system 201), the encoded quantum control computation.

Looking now to operations 410, 412, 414, 416, and/or 418, any one or more of such operations can be employed as part of the applying, by the system, of one or more specified variables to the original quantum control computation.

At 410, the non-limiting method 400 can comprise applying, by the system (e.g., obfuscation component 112), to the original quantum control computation, a gate, a gate string, a qubit rotation value, and/or a modification to a qubit rotation value of the original quantum control computation.

At 412, the non-limiting method 400 can comprise applying, by the system (e.g., obfuscation component 112), a gate or gate string comprising a CNOT gate and an RZ gate, a pair of Hadamard gates, and/or a CNOT gate and a SWAP gate.

At 414, the non-limiting method 400 can comprise splitting, by the system (e.g., obfuscation component 112), a qubit rotation value of the original quantum control computation. For example, in one or more embodiments, a real-valued parameter A can be split into A and A-x by a random real-valued x.

At 416, the non-limiting method 400 can comprise down replacing, by the system (e.g., obfuscation component 112), a gate or a qubit rotation value of the original quantum control computation, such as by replacing a gate by commuting together two or more gates.

At 418, the non-limiting method 400 can comprise increasing, by the system (e.g., obfuscation component 112), a size of the original quantum circuit polynomially. That is, such increase can be provided by operation of any one or more of operations 410, 412, 414 and/or 416, for example.

Turning next to FIGS. 5 and 6, description is provided regarding one or more methods to facilitate obfuscation of one or more gate parameters of a quantum circuit, such as of an RZ gate. In one or more embodiments, one or more of the techniques described above for obfuscation relative to FIG. 3 and/or 4 can be applied to obfuscate one or more gate parameters of a quantum circuit. For example, one or more parameters of RZ gates can be obfuscated.

Again, one or more reverse quantum operations can be performed to decode such encoded circuit, and thus such encoding can be performed to protect against third parties having no access to a quantum computer, or no access to a quantum computer with sufficient capabilities to reverse one or more of the obfuscations discussed herein.

In one example, a group of RZ rotations can be selected, such as by the obfuscation component 112 and/or the user, and such can be applied with; for example, some k digits. For example, for each RZ^{v}(α) in the circuit choose a random bit string (b₁, b₂, ..., bₖ). Accordingly, Eq. 1^{:} RZ^{v}(α) = Π_{j=1..k:jth} binary component of α under encoding (b₁,b₂,...,bₖ) is

$${}_{1} {\text{RZ}}^{v} \left(\frac{{\left(- 1\right)}^{{b}_{j}} 2 π \text{} i}{{2}^{j}}\right) .$$

Such a decomposition can exist for any selection of the string (b₁, b₂, ..., bₖ). Randomness can be introduced by b’s since b can hide one or more possible structures to the gate angles used, independently of what follows next.

To implement RZ^{v}(α), for example, can be rewritten as, Eq. 2: controlled

$$- {\text{RZ}}^{v} \left(\frac{{\left(- 1\right)}^{{b}_{1}} 2 π \text{} i}{{2}^{1}}\right)$$

... controlled

$$- {\text{RZ}}^{v} \left(\frac{{\left(- 1\right)}^{{b}_{2}} 2 π \text{} i}{{2}^{2}}\right)$$

... controlled -

$${\text{RZ}}^{v} \left(\frac{{\left(- 1\right)}^{{b}_{k}} 2 π \text{} i}{{2}^{k}}\right) ,$$

which can be controlled on a selection of ancillary qubits carrying hidden signals that can be selectively determined by the user or by the obfuscation component 112, for example, and thus such signals can be unknown to third parties.

The ancillary qubits can be initiated to the state |0〉 and before such ancillary qubits are employed, such as by a quantum system 201, such ancillary qubits at the encoded quantum circuit can have introduced thereto a random Pauli layer. This can create, by the obfuscation component 112, a random set of zeroes and ones.

Further, along with true experiments, the user can prepare a quantum circuit (rather than a random Pauli layer) that can compute the function the user knows and wants to employ for the purpose of obfuscation. The result of this part of the computation can comprise non-useful output in terms of the true computation, but the resulting qubit values can be used to obfuscate true computations and are known to the user.

Relative to these one or more methods of obfuscation, e.g., of an input specification of a quantum circuit, FIG. 5 illustrates a process diagram of an example, non-limiting method 500 that can facilitate obfuscation of one or more gate parameters of a quantum circuit. Repetitive description of like elements and/or processes employed in respective embodiments is omitted for sake of brevity.

At 504, the non-limiting method 500 can comprise determining, by a system, (e.g., determination component 110) an original quantum control computation.

At 506, the non-limiting method 500 can comprise selecting, by the system (e.g., obfuscation component 112), a group of qubit rotation values, such as by employing Eq. 1, above. At 508, the non-limiting method 500 can comprise introducing, by the system (e.g., obfuscation component 112), a random variable to the qubit rotation values of the original quantum control computation. That is, control can be based on a selection of ancillary qubits carrying hidden signals that can be selectively determined by the user or by the obfuscation component 112, for example, and thus such signals can be unknown to third parties.

At 510, the non-limiting method 500 can comprise generating, by the system (e.g., obfuscation component 112), an encoded quantum control computation different from the original quantum control computation.

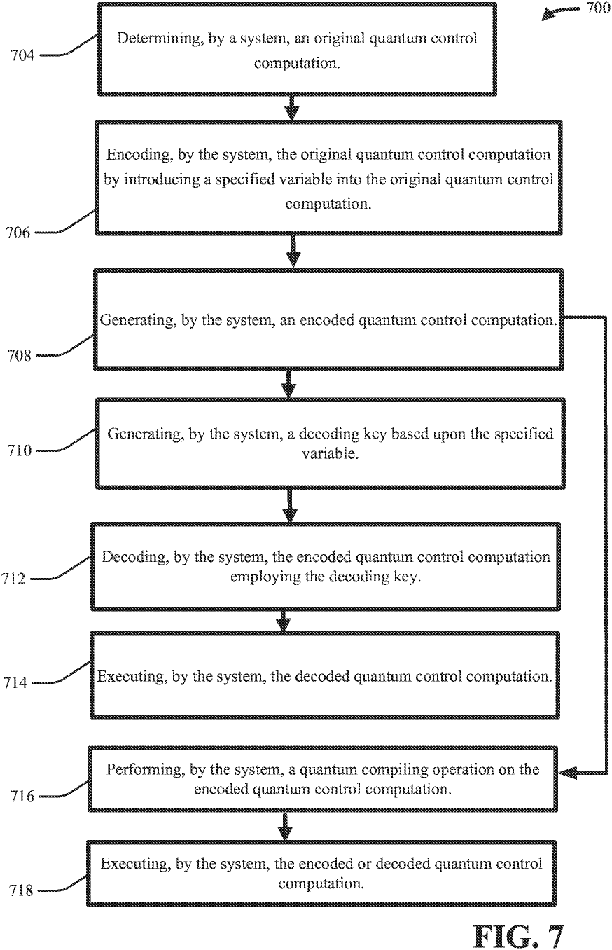

Next, FIG. 7 illustrates a process diagram of an example, non-limiting method 700 that can generally facilitate obfuscation of a quantum circuit, such as being applicable to obfuscation of at least a portion of a quantum circuit input specification, to obfuscation of one or more gate parameters of a quantum circuit, and/or to obfuscation of a portion or entirety of a quantum circuit. Repetitive description of like elements and/or processes employed in respective embodiments is omitted for sake of brevity.

At 704, the non-limiting method 700 can comprise determining, by a system, (e.g., determination component 110) an original quantum control computation.

At 706, the non-limiting method 700 can comprise encoding, by the system (e.g., obfuscation component 112), the original quantum control computation by introducing a specified variable into the original quantum control computation. Different one or more specified variable can be employed for different methods of obfuscating: at least a portion of an input specification, one or more gate parameters, or one or more portions of a quantum circuit.

At 708, the non-limiting method 700 can comprise generating, by the system (e.g., obfuscation component 112), an encoded quantum control computation. That is, regardless of the different one or more specified variables introduced into the original quantum control computation, an encoded quantum control computation can be generated.

At 710, the non-limiting method 700 can comprise generating, by the system (e.g., obfuscation component 112), a decoding key based upon the specified variable. That is, the specified variable employed to generate the encoded quantum control computation can be such that the encoded quantum control computation cannot be executed absent first decoding thereof. See, e.g., FIG. 3 and all discussion above therewith and referring to obfuscation of at least a portion of an input specification of a quantum control computation, relative to 710, 712 and 714.

At 712, the non-limiting method 700 can comprise decoding, by the system (e.g., obfuscation component 112), the encoded quantum control computation employing the decoding key.

At 714, the non-limiting method 700 can comprise executing, by the system (e.g., quantum system 201), the decoded quantum control computation.

Alternatively, after encoding the quantum control computation at 708, such as employing a different one or more specified variables, the non-limiting method 700 can comprise, one or more of 716 and/or 719. See, e.g., FIG. 4 and all discussion above therewith and referring to obfuscation of one or more portions of a quantum control computation, relative to 716 and 718.

At 718, the non-limiting method 700 can comprise executing, by the system (e.g., quantum system 201), the encoded quantum control computation.

Although, at 716, in one or more cases, one or more quantum operations can first be performed on the encoded quantum control computation to at least partially decode the encoded quantum control computation. This can be done, for example, to lessen the amount of processing power, qubit number and/or time employed for executing the encoded quantum control computation. Such one or more quantum operations can be performed and/or operated on the encoded quantum control computation by the quantum processor 206 and/or quantum operation component 203, for example. And thus, in one or more other embodiments, 716 can be employed and can comprise performing, by the system (e.g., quantum system 201), a quantum compiling operation on the encoded quantum control computation. The quantum compiling operation can comprise a decompiling operation.

For simplicity of explanation, the computer-implemented and non-computer-implemented methodologies provided herein are depicted and/or described as a series of acts. The subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture to facilitate transporting and transferring the computer-implemented methodologies to computers. The term article of manufacture, as used herein, is intended to encompass a computer program accessible from any computer-readable device or storage media.

In summary, one or more systems, computer-implemented methods and/or computer program products provided herein relate to obfuscating an input specification of a quantum circuit, one or more gate parameters of a quantum circuit, and/or at least a portion of a quantum circuit. A system can comprise a processor, operatively coupled to a memory, wherein the processor executes the following computer executable components: an obfuscation component that encodes an original quantum control computation by introducing a specified variable into the original quantum control computation, wherein the introduction of the specified variable creates an encoded quantum control computation that is decodable by employing a decoding key or by performing a quantum compiling operation on the encoded quantum control computation using a quantum processor to reverse the encoding.

An advantage of the system, computer-implemented method and/or computer program product can be that an outside third party, eavesdropper, hacker, cloud provider and/or quantum-service provider can be unable to determine at least one of a quantum specification, quantum gate parameter and/or a portion or entirety of the original quantum circuit (e.g., quantum control computation). That is, by obfuscating (e.g., encoding) at least an element of the original quantum control computation, the original quantum control computation can be secured and/or encoded at least partially. Depending on the level of obfuscation, the encoded quantum control computation can still be executed by employing a quantum processor, such as on a respective quantum system. Alternatively, depending on the level of obfuscation, a decoding of the encoded quantum control computation can be employed prior to execution of the decoded quantum control computation.

Another advantage of the system, computer-implemented method and/or computer program product can be generation of an encoded quantum control computation that can be too complex, difficult and/or large to execute by other than a sufficiently large, and/or complex quantum processor and/or quantum system, such as where a client intends to execute the original quantum control computation in the first instance. Size and/or complexity of a quantum processor and/or quantum system can be based on physical, real-world qubit quantity, qubit layout and/or qubit control software of the quantum processor and/or quantum system.

Indeed, in view of the one or more embodiments described herein, a practical application of the devices described herein can be ability to at least partially secure, obfuscate and/or encode at least an element of a quantum circuit from a third party, eavesdropper, hacker, cloud provider and/or quantum system provider. This is a useful and practical application of computers, especially in view of a proprietary nature of quantum circuits to clients, generators and/or the like. Overall, such computerized tools can constitute a concrete and tangible technical improvement in the field of quantum computing.

Furthermore, one or more embodiments described herein can be employed in a real-world system based on the disclosed teachings. For example, one or more embodiments described herein can function within a quantum system that can receive as input a quantum job request and can measure a real-world qubit state of one or more qubits, such as superconducting qubits, of the quantum system.

Moreover, a device and/or method described herein can be implemented in one or more domains, such as quantum domains, to enable scaled quantum program executions. Indeed, use of a device as described herein can be scalable, such as where a device, system, computer-implemented method and/or computer program product described herein can be employed in quantity to encode, secure and/or obfuscate a plurality of elements of a quantum circuit and/or a plurality of quantum circuits and/or portions thereof, either of which, or a combination of which, can be performed at least partially simultaneously with one another.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can be, in one or more embodiments, inherently and/or inextricably tied to computer technology and cannot be implemented outside of a computing environment. For example, one or more processes performed by one or more embodiments described herein can more efficiently, and even more feasibly, provide program and/or program instruction execution, such as relative to modification of a quantum circuit, as compared to existing systems and/or techniques. Systems, computer-implemented methods and/or computer program products facilitating performance of these processes are of great utility in the field of quantum computing and superconducting quantum systems and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively encode a quantum circuit as the one or more embodiments described herein can facilitate this process. And, neither can the human mind nor a human with pen and paper encode a quantum circuit, as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing the one or more operations described herein.

Turning next to FIGS. 8-10, a detailed description is provided of additional context for the one or more embodiments described herein at FIGS. 1-7.

FIG. 8 and the following discussion are intended to provide a brief, general description of a suitable operating environment 800 in which one or more embodiments described herein at FIGS. 1-7 can be implemented. For example, one or more components and/or other aspects of embodiments described herein can be implemented in or be associated with, such as accessible via, the operating environment 800. Further, while one or more embodiments have been described above in the general context of computer-executable instructions that can run on one or more computers, those skilled in the art will recognize that one or more embodiments also can be implemented in combination with other program modules and/or as a combination of hardware and software.

Generally, program modules include routines, programs, components, data structures and/or the like, that perform particular tasks and/or implement particular abstract data types. Moreover, the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and/or the like, each of which can be operatively coupled to one or more associated devices.

Computing devices typically include a variety of media, which can include computer-readable storage media, machine-readable storage media and/or communications media, which two terms are used herein differently from one another as follows. Computer-readable storage media or machine-readable storage media can be any available storage media that can be accessed by the computer and includes both volatile and nonvolatile media, removable and non-removable media. By way of example, but not limitation, computer-readable storage media and/or machine-readable storage media can be implemented in connection with any method or technology for storage of information such as computer-readable and/or machine-readable instructions, program modules, structured data and/or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) and/or other optical disk storage, magnetic cassettes, magnetic tape, magnetic disk storage and/or other magnetic storage devices, solid state drives or other solid state storage devices and/or other tangible and/or non-transitory media which can be used to store specified information. In this regard, the terms “tangible” or “non-transitory” herein as applied to storage, memory and/or computer-readable media, are to be understood to exclude only propagating transitory signals per se as modifiers and do not relinquish rights to all standard storage, memory and/or computer-readable media that are not only propagating transitory signals per se.

Computer-readable storage media can be accessed by one or more local or remote computing devices, e.g., via access requests, queries and/or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set and/or changed in such a manner as to encode information in one or more signals. By way of example, but not limitation, communication media can include wired media, such as a wired network, direct-wired connection and/or wireless media such as acoustic, RF, infrared and/or other wireless media.

With reference again to FIG. 8, the example operating environment 800 for implementing one or more embodiments of the aspects described herein can include a computer 802, the computer 802 including a processing unit 806, a system memory 804 and/or a system bus 808. One or more aspects of the processing unit 806 can be applied to processors such as 106 of the non-limiting system 100. The processing unit 806 can be implemented in combination with and/or alternatively to processors such as 106.

Memory 804 can store one or more computer and/or machine readable, writable and/or executable components and/or instructions that, when executed by processing unit 806 (e.g., a classical processor, a quantum processor and/or like processor), can facilitate performance of operations defined by the executable component(s) and/or instruction(s). For example, memory 804 can store computer and/or machine readable, writable and/or executable components and/or instructions that, when executed by processing unit 806, can facilitate execution of the one or more functions described herein relating to non-limiting system 100, as described herein with or without reference to the one or more figures of the one or more embodiments.

Memory 804 can comprise volatile memory (e.g., random access memory (RAM), static RAM (SRAM), dynamic RAM (DRAM) and/or the like) and/or non-volatile memory (e.g., read only memory (ROM), programmable ROM (PROM), electrically programmable ROM (EPROM), electrically erasable programmable ROM (EEPROM) and/or the like) that can employ one or more memory architectures.

Processing unit 806 can comprise one or more types of processors and/or electronic circuitry (e.g., a classical processor, a quantum processor and/or like processor) that can implement one or more computer and/or machine readable, writable and/or executable components and/or instructions that can be stored at memory 804. For example, processing unit 806 can perform one or more operations that can be specified by computer and/or machine readable, writable and/or executable components and/or instructions including, but not limited to, logic, control, input/output (I/O), arithmetic and/or the like. In one or more embodiments, processing unit 806 can be any of one or more commercially available processors. In one or more embodiments, processing unit 806 can comprise one or more central processing unit, multi-core processor, microprocessor, dual microprocessors, microcontroller, System on a Chip (SOC), array processor, vector processor, quantum processor and/or another type of processor. The examples of processing unit 806 can be employed to implement one or more embodiments described herein.

The system bus 808 can couple system components including, but not limited to, the system memory 804 to the processing unit 806. The system bus 808 can comprise one or more types of bus structure that can further interconnect to a memory bus (with or without a memory controller), a peripheral bus and/or a local bus using one or more of a variety of commercially available bus architectures. The system memory 804 can include ROM 810 and/or RAM 812. A basic input/output system (BIOS) can be stored in a non-volatile memory such as ROM, erasable programmable read only memory (EPROM) and/or EEPROM, which BIOS contains the basic routines that help to transfer information among elements within the computer 802, such as during startup. The RAM 812 can include a high-speed RAM, such as static RAM for caching data.

The computer 802 can include an internal hard disk drive (HDD) 814 (e.g., EIDE, SATA), one or more external storage devices 816 (e.g., a magnetic floppy disk drive (FDD), a memory stick or flash drive reader, a memory card reader and/or the like) and/or a drive 820, e.g., such as a solid state drive or an optical disk drive, which can read or write from a disk 822, such as a CD-ROM disc, a DVD, a BD and/or the like. Additionally, and/or alternatively, where a solid state drive is involved, disk 822 could not be included, unless separate. While the internal HDD 814 is illustrated as located within the computer 802, the internal HDD 814 can also be configured for external use in a suitable chassis (not shown). Additionally, while not shown in operating environment 800, a solid state drive (SSD) can be used in addition to, or in place of, an HDD 814. The HDD 814, external storage device(s) 816 and drive 820 can be connected to the system bus 808 by an HDD interface 824, an external storage interface 826 and a drive interface 828, respectively. The HDD interface 824 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 802, the drives and storage media accommodate the storage of any data in a suitable digital format. Although the description of computer-readable storage media above refers to respective types of storage devices, other types of storage media which are readable by a computer, whether presently existing or developed in the future, can also be used in the example operating environment, and/or that any such storage media can contain computer-executable instructions for performing the methods described herein.

A number of program modules can be stored in the drives and RAM 812, including an operating system 830, one or more applications 832, other program modules 834 and/or program data 836. All or portions of the operating system, applications, modules and/or data can also be cached in the RAM 812. The systems and/or methods described herein can be implemented utilizing one or more commercially available operating systems and/or combinations of operating systems.

Computer 802 can optionally comprise emulation technologies. For example, a hypervisor (not shown) or other intermediary can emulate a hardware environment for operating system 830, and the emulated hardware can optionally be different from the hardware illustrated in FIG. 8. In a related embodiment, operating system 830 can comprise one virtual machine (VM) of multiple VMs hosted at computer 802. Furthermore, operating system 830 can provide runtime environments, such as the JAVA runtime environment or the .NET framework, for applications 832. Runtime environments are consistent execution environments that can allow applications 832 to run on any operating system that includes the runtime environment. Similarly, operating system 830 can support containers, and applications 832 can be in the form of containers, which are lightweight, standalone, executable packages of software that include, e.g., code, runtime, system tools, system libraries and/or settings for an application.

Further, computer 802 can be enabled with a security module, such as a trusted processing module (TPM). For instance, with a TPM, boot components hash next in time boot components and wait for a match of results to secured values before loading a next boot component. This process can take place at any layer in the code execution stack of computer 802, e.g., applied at application execution level and/or at operating system (OS) kernel level, thereby enabling security at any level of code execution.

An entity can enter and/or transmit commands and/or information into the computer 802 through one or more wired/wireless input devices, e.g., a keyboard 838, a touch screen 840 and/or a pointing device, such as a mouse 842. Other input devices (not shown) can include a microphone, an infrared (IR) remote control, a radio frequency (RF) remote control and/or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint and/or iris scanner, and/or the like. These and other input devices can be connected to the processing unit 806 through an input device interface 844 that can be coupled to the system bus 808, but can be connected by other interfaces, such as a parallel port, an IEEE 1394 serial port, a game port, a USB port, an IR interface, a BLUETOOTH® interface and/or the like.

A monitor 846 or other type of display device can be alternatively and/or additionally connected to the system bus 808 via an interface, such as a video adapter 848. In addition to the monitor 846, a computer typically includes other peripheral output devices (not shown), such as speakers, printers and/or the like.

The computer 802 can operate in a networked environment using logical connections via wired and/or wireless communications to one or more remote computers, such as a remote computer(s) 850. The remote computer(s) 850 can be a workstation, a server computer, a router, a personal computer, portable computer, microprocessor-based entertainment appliance, a peer device and/or other common network node, and typically includes many or all of the elements described relative to the computer 802, although, for purposes of brevity, only a memory/storage device 852 is illustrated. Additionally, and/or alternatively, the computer 802 can be coupled (e.g., communicatively, electrically, operatively, optically and/or the like) to one or more external systems, sources and/or devices (e.g., classical and/or quantum computing devices, communication devices and/or like device) via a data cable (e.g., High-Definition Multimedia Interface (HDMI), recommended standard (RS) 232, Ethernet cable and/or the like).

In one or more embodiments, a network can comprise one or more wired and/or wireless networks, including, but not limited to, a cellular network, a wide area network (WAN) (e.g., the Internet), or a local area network (LAN). For example, one or more embodiments described herein can communicate with one or more external systems, sources and/or devices, for instance, computing devices (and vice versa) using virtually any specified wired or wireless technology, including but not limited to: wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (IPv6 over Low power Wireless Area Networks), Z-Wave, an ANT, an ultra-wideband (UWB) standard protocol and/or other proprietary and/or non-proprietary communication protocols. In a related example, one or more embodiments described herein can include hardware (e.g., a central processing unit (CPU), a transceiver, a decoder, quantum hardware, a quantum processor and/or the like), software (e.g., a set of threads, a set of processes, software in execution, quantum pulse schedule, quantum circuit, quantum gates and/or the like) and/or a combination of hardware and/or software that facilitates communicating information among one or more embodiments described herein and external systems, sources and/or devices (e.g., computing devices, communication devices and/or the like).

The logical connections depicted include wired/wireless connectivity to a local area network (LAN) 854 and/or larger networks, e.g., a wide area network (WAN) 856. LAN and WAN networking environments can be commonplace in offices and companies and can facilitate enterprise-wide computer networks, such as intranets, all of which can connect to a global communications network, e.g., the Internet.

When used in a LAN networking environment, the computer 802 can be connected to the local network 854 through a wired and/or wireless communication network interface or adapter 858. The adapter 858 can facilitate wired and/or wireless communication to the LAN 854, which can also include a wireless access point (AP) disposed thereon for communicating with the adapter 858 in a wireless mode.

When used in a WAN networking environment, the computer 802 can include a modem 860 and/or can be connected to a communications server on the WAN 856 via other means for establishing communications over the WAN 856, such as by way of the Internet. The modem 860, which can be internal and/or external and a wired and/or wireless device, can be connected to the system bus 808 via the input device interface 844. In a networked environment, program modules depicted relative to the computer 802 or portions thereof can be stored in the remote memory/storage device 852. The network connections shown are merely exemplary and one or more other means of establishing a communications link among the computers can be used.

When used in either a LAN or WAN networking environment, the computer 802 can access cloud storage systems or other network-based storage systems in addition to, and/or in place of, external storage devices 816 as described above, such as but not limited to, a network virtual machine providing one or more aspects of storage and/or processing of information. Generally, a connection between the computer 802 and a cloud storage system can be established over a LAN 854 or WAN 856 e.g., by the adapter 858 or modem 860, respectively. Upon connecting the computer 802 to an associated cloud storage system, the external storage interface 826 can, such as with the aid of the adapter 858 and/or modem 860, manage storage provided by the cloud storage system as it would other types of external storage. For instance, the external storage interface 826 can be configured to provide access to cloud storage sources as if those sources were physically connected to the computer 802.

The computer 802 can be operable to communicate with any wireless devices and/or entities operatively disposed in wireless communication, e.g., a printer, scanner, desktop and/or portable computer, portable data assistant, communications satellite, telephone and/or any piece of equipment or location associated with a wirelessly detectable tag (e.g., a kiosk, news stand, store shelf and/or the like). This can include Wireless Fidelity (Wi-Fi) and BLUETOOTH® wireless technologies. Thus, the communication can be a predefined structure as with a conventional network or simply an ad hoc communication between at least two devices.

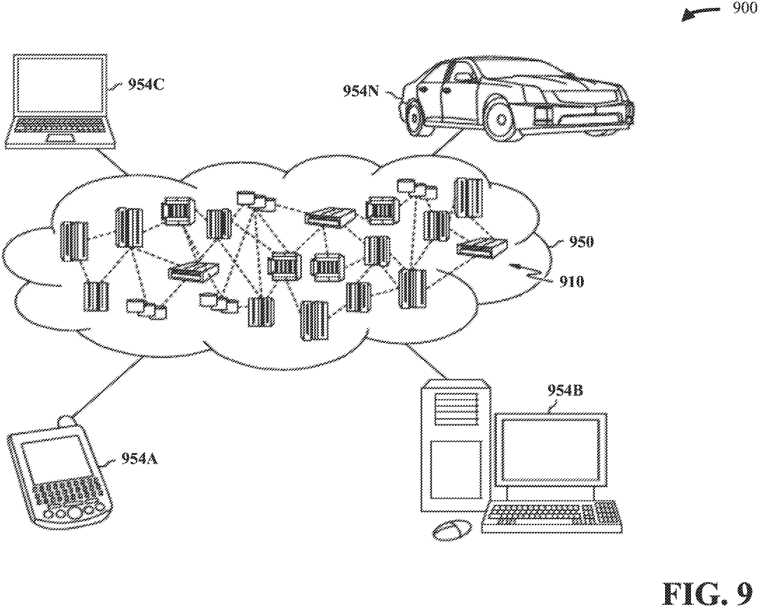

The illustrated embodiments described herein can be employed relative to distributed computing environments (e.g., cloud computing environments), such as described below with respect to FIG. 9, where certain tasks are performed by remote processing devices that are linked through a communications network. In a distributed computing environment, program modules can be located both in local and/or remote memory storage devices.

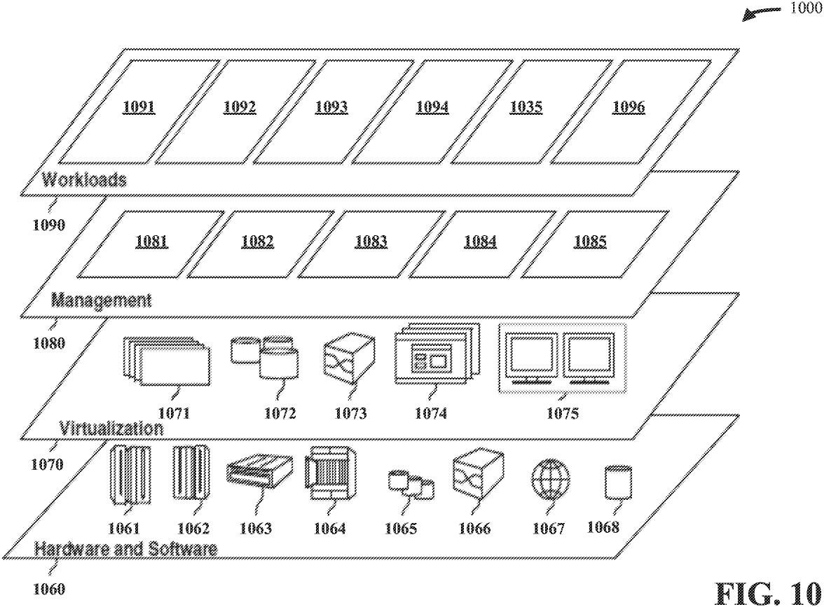

For example, one or more embodiments described herein and/or one or more components thereof can employ one or more computing resources of the cloud computing environment 950 described below with reference to FIG. 9, and/or with reference to the one or more functional abstraction layers (e.g., quantum software and/or the like) described below with reference to FIG. 10, to execute one or more operations in accordance with one or more embodiments described herein. For example, cloud computing environment 950 and/or one or more of the functional abstraction layers 1060, 1070, 1080 and/or 1090 can comprise one or more classical computing devices (e.g., classical computer, classical processor, virtual machine, server and/or the like), quantum hardware and/or quantum software (e.g., quantum computing device, quantum computer, quantum processor, quantum circuit simulation software, superconducting circuit and/or the like) that can be employed by one or more embodiments described herein and/or components thereof to execute one or more operations in accordance with one or more embodiments described herein. For instance, one or more embodiments described herein and/or components thereof can employ such one or more classical and/or quantum computing resources to execute one or more classical and/or quantum: mathematical function, calculation and/or equation; computing and/or processing script; algorithm; model (e.g., artificial intelligence (AI) model, machine learning (ML) model and/or like model); and/or other operation in accordance with one or more embodiments described herein.

It is to be understood that although one or more embodiments described herein include a detailed description on cloud computing, implementation of the teachings recited herein are not limited to a cloud computing environment. Rather, one or more embodiments described herein are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines and/or services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can specify location at a higher level of abstraction (e.g., country, state and/or datacenter).

Rapid elasticity: capabilities can be rapidly and elastically provisioned, in one or more cases automatically, to quickly scale out and rapidly released to quickly scale in. To the consumer, the capabilities available for provisioning can appear to be unlimited and can be purchased in any quantity at any time.

Measured service: cloud systems automatically control and optimize resource use by leveraging a metering capability at one or more levels of abstraction appropriate to the type of service (e.g., storage, processing, bandwidth and/or active user accounts). Resource usage can be monitored, controlled and/or reported, providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage and/or individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems and/or storage, but has control over the deployed applications and possibly application hosting environment configurations.

Infrastructure as a Service (IaaS): the capability provided to the consumer is to provision processing, storage, networks and/or other fundamental computing resources where the consumer can deploy and run arbitrary software, which can include operating systems and applications. The consumer does not manage or control the underlying cloud infrastructure but has control over operating systems, storage, deployed applications and/or possibly limited control of select networking components (e.g., host firewalls).

Deployment Models are as follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy and/or compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community or public) that remain unique entities but are bound together by standardized or proprietary technology that enables data and application portability (e.g., cloud bursting for load-balancing among clouds).

A cloud computing environment is service oriented with a focus on statelessness, low coupling, modularity and/or semantic interoperability. At the heart of cloud computing is an infrastructure that includes a network of interconnected nodes.

Moreover, the non-limiting system 100 and/or the example operating environment 800 can be associated with and/or be included in a data analytics system, a data processing system, a graph analytics system, a graph processing system, a big data system, a social network system, a speech recognition system, an image recognition system, a graphical modeling system, a bioinformatics system, a data compression system, an artificial intelligence system, an authentication system, a syntactic pattern recognition system, a medical system, a health monitoring system, a network system, a computer network system, a communication system, a router system, a server system, a high availability server system (e.g., a Telecom server system), a Web server system, a file server system, a data server system, a disk array system, a powered insertion board system, a cloud-based system and/or the like. In accordance therewith, non-limiting system 100 and/or example operating environment 800 can be employed to use hardware and/or software to solve problems that are highly technical in nature, that are not abstract and/or that cannot be performed as a set of mental acts by a human.

Referring now to details of one or more aspects illustrated at FIG. 9, the illustrative cloud computing environment 950 is depicted. As shown, cloud computing environment 950 includes one or more cloud computing nodes 910 with which local computing devices used by cloud consumers, such as, for example, personal digital assistant (PDA) or cellular telephone 954A, desktop computer 954B, laptop computer 954C and/or automobile computer system 954N can communicate. Although not illustrated in FIG. 9, cloud computing nodes 910 can further comprise a quantum platform (e.g., quantum computer, quantum hardware, quantum software and/or the like) with which local computing devices used by cloud consumers can communicate. Cloud computing nodes 910 can communicate with one another. They can be grouped (not shown) physically or virtually, in one or more networks, such as Private, Community, Public, or Hybrid clouds as described hereinabove, or a combination thereof. This allows cloud computing environment 950 to offer infrastructure, platforms and/or software as services for which a cloud consumer does not need to maintain resources on a local computing device. It is understood that the types of computing devices 954A-N shown in FIG. 9 are intended to be illustrative only and that cloud computing nodes 910 and cloud computing environment 950 can communicate with any type of computerized device over any type of network and/or network addressable connection (e.g., using a web browser).

Referring now to details of one or more aspects illustrated at FIG. 10, a set 1000 of functional abstraction layers is shown, such as provided by cloud computing environment 950 (FIG. 9). One or more embodiments described herein can be associated with, such as accessible via, one or more functional abstraction layers described below with reference to FIG. 10 (e.g., hardware and software layer 1060, virtualization layer 1070, management layer 1080 and/or workloads layer 1090). It should be understood in advance that the components, layers and/or functions shown in FIG. 10 are intended to be illustrative only and embodiments described herein are not limited thereto. As depicted, the following layers and/or corresponding functions are provided:

Hardware and software layer 1060 can include hardware and software components. Examples of hardware components include: mainframes 1061; RISC (Reduced Instruction Set Computer) architecture-based servers 1062; servers 1063; blade servers 1064; storage devices 1065; and/or networks and/or networking components 1066. In one or more embodiments, software components can include network application server software 1067, quantum platform routing software 1068; and/or quantum software (not illustrated in FIG. 10).

Virtualization layer 1070 can provide an abstraction layer from which the following examples of virtual entities can be provided: virtual servers 1071; virtual storage 1072; virtual networks 1073, including virtual private networks; virtual applications and/or operating systems 1074; and/or virtual clients 1075.

In one example, management layer 1080 can provide the functions described below. Resource provisioning 1081 can provide dynamic procurement of computing resources and other resources that can be utilized to perform tasks within the cloud computing environment. Metering and Pricing 1082 can provide cost tracking as resources are utilized within the cloud computing environment, and/or billing and/or invoicing for consumption of these resources. In one example, these resources can include one or more application software licenses. Security can provide identity verification for cloud consumers and/or tasks, as well as protection for data and/or other resources. User (or entity) portal 1083 can provide access to the cloud computing environment for consumers and system administrators. Service level management 1084 can provide cloud computing resource allocation and/or management such that required service levels are met. Service Level Agreement (SLA) planning and fulfillment 1085 can provide pre-arrangement for, and procurement of, cloud computing resources for which a future requirement is anticipated in accordance with an SLA.

Workloads layer 1090 can provide examples of functionality for which the cloud computing environment can be utilized. Non-limiting examples of workloads and functions which can be provided from this layer include: mapping and navigation 1091; software development and lifecycle management 1092; virtual classroom education delivery 1093; data analytics processing 1094; transaction processing 1095; and/or application transformation software 1096.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented in combination with one or more other program modules. Generally, program modules include routines, programs, components, data structures and/or the like that perform particular tasks and/or implement particular abstract data types. Moreover, the inventive computer-implemented methods can be practiced with other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a processor, operatively coupled to a memory, wherein the processor executes the following computer executable components:
an obfuscation component that encodes an original quantum control computation by introducing a specified variable into the original quantum control computation,
wherein the introduction of the specified variable creates an encoded quantum control computation that is decodable by performing a quantum compiling operation on the encoded quantum control computation.

2. The system of claim 1, further comprising employing a decoding key, generated by the obfuscation component based upon the specified variable, to decode the encoded quantum control computation.

3. The system of claim 1, wherein the specified variable comprises a gate, a gate string, a qubit rotation value, or a modification to a qubit rotation value of the original quantum control computation.

4. The system of claim 3, wherein the gate or gate string comprises a CNOT gate and RZ gate, a pair of Hadamard gates, or a CNOT gate and a SWAP gate.

5. The system of claim 3, wherein the modification to a qubit rotation value of the original quantum control computation comprises splitting a qubit rotation value.

6. The system of claim 3, wherein the encoding further comprises replacing a gate or a qubit rotation value of the original quantum control computation with the specified variable.

7. The system of claim 6, wherein the replacing a gate comprises commuting together two or more gates of the original quantum control computation.

8. The system of claim 1, wherein the encoding comprises generating an n-qubit Pauli-X layer, being the specified variable.

9. The system of claim 1, wherein the encoding comprises increasing a size of a quantum control computation polynomially.

10. A computer-implemented method, comprising:
encoding, by a system operatively coupled to a processor, an original quantum control computation by introducing a specified variable into the original quantum control computation,
wherein the introduction of the specified variable creates an encoded quantum control computation that is decodable by performing, by the system, a quantum compiling operation on the encoded quantum control computation.

11. The computer-implemented method of claim 10, further comprising:
generating, by the system, a decoding key based upon the specified variable; and
employing, by the system, the decoding key to decode the encoded quantum control computation.

12. The computer-implemented method of claim 10, wherein the specified variable comprises a gate, a gate string, a qubit rotation value, or a modification to a qubit rotation value of the original quantum control computation.

13. The computer-implemented method of claim 10,
wherein the gate or gate string comprises a CNOT gate and RZ gate, a pair of Hadamard gates, or a CNOT gate and a SWAP gate, or
wherein the modification to a qubit rotation value of the original quantum control computation comprises splitting a qubit rotation value.

14. The computer-implemented method of claim 10, wherein the encoding further comprises replacing, by the system, a gate or a qubit rotation value of the original quantum control computation with the specified variable.

15. A computer program product facilitating a process to obfuscate a quantum control computation, the computer program product comprising a non-transitory computer readable storage medium having program instructions embodied therewith, the program instructions executable by a processor to cause the processor to:
encode, by the processor, an original quantum control computation by introducing a specified variable into the original quantum control computation,
wherein the introduction of the specified variable creates an encoded quantum control computation that is decodable by performing, by the processor, a quantum compiling operation on the encoded quantum control computation.

16. The computer program product of claim 15, wherein the program instructions are further executable by a processor to cause the processor to:
generate, by the processor, a decoding key based upon the specified variable; and
employ, by the processor, the decoding key to decode the encoded quantum control computation.

17. The computer program product of claim 15, wherein the specified variable comprises a gate, a gate string, a qubit rotation value, or a modification to a qubit rotation value of the original quantum control computation.

18. The computer program product of claim 15,
wherein the gate or gate string comprises a CNOT gate and RZ gate, a pair of Hadamard gates, or a CNOT gate and a SWAP gate, or
wherein the modification to a qubit rotation value of the original quantum control computation comprises splitting a qubit rotation value.

19. The computer program product of claim 15, wherein the program instructions are further executable by a processor to cause the processor to:
encode, by the processor, by replacing, by the processor, a gate or a qubit rotation value of the original quantum control computation with the specified variable.

20. A system, comprising:
a processor, operatively coupled to a memory, wherein the processor executes the following computer executable components:
an obfuscation component that encodes an original quantum control computation by introducing a n-qubit Pauli-X layer into the original qubit control computation,
wherein the introduction of the specified variable creates an encoded quantum control computation that is decodable by employing a decoding key.

21. The system of claim 20, wherein the obfuscation component further generates the decoding key based upon the n-qubit Pauli-X layer.

22. The system of claim 20, wherein the obfuscation component further generates the n-qubit Pauli-X layer.

23. A computer-implemented method, comprising:
encoding, by a system operatively coupled to a processor, an original quantum control computation by introducing a n-qubit Pauli-X layer into the original qubit control computation,
wherein the introduction of the specified variable creates an encoded quantum control computation that is decodable by employing a decoding key.

24. The method of claim 23, further comprising:
generating, by the system, the decoding key based upon the n-qubit Pauli-X layer.

25. The method of claim 23, further comprising:
generating, by the system, the n-qubit Pauli-X layer.
